(19) United States
(12) Patent Application Publication
(10) Pub. No.: US 2025/0132368 A1
(43) Pub. Date: Apr. 24, 2025

(54) FUEL CELL MODULE

(71) Applicant: ContiTech Deutschland GmbH, Hannover (DE)

(72) Inventors: Lukas Kuehne, Seelze (DE); Stefan Narberhaus, Garbsen (DE); Bohui Chen, Haiyu Town (CN); Jiatong Wu, Changshu (CN)

(73) Assignee: ContiTech Deutschland GmbH, Hannover (DE)

(21) Appl. No.: 18/722,078

(22) PCT Filed: Dec. 10, 2022
(86) PCT No.: PCT/EP2022/087141

§ 371 Date: Jun. 20, 2024

(30) Foreign Application Priority Data
Dec. 20, 2021 (CN) 202111564061.7

(51) Int. Cl. H01M 8/2485; H01M 8/04007; H01M 8/0438; H01M 8/0444; H01M 8/04492

(52) U.S. Cl. CPC H01M 8/2485; H01M 8/04007; H01M 8/0438; H01M 8/04447; H01M 8/04492

(57) ABSTRACT

A fuel cell module is disclosed and includes a plastic base and an aluminum plate. The plastic base 102 is comprised of a polymer material. The plastic base 102 comprises a coolant inlet, an air inlet, a coolant channel, an air channel and a fuel channel. The aluminum plate 104 is attached to a top portion of the plastic base 102. The plate 104 can comprises a fuel inlet and a water outlet that connect to the fuel channel of the plastic base.

The present application is a National Stage Application under 35 U.S.C § 371 of International Patent Application No. PCT/EP2022/087171 filed on Dec. 20, 2022, and claims priority from Chinese Patent Application No. 202111564061.7 filed on Dec. 20, 2021, the disclosures of which are herein incorporated by reference in their entireties.

### FIELD

The disclosure generally relates to systems and methods for fuel cell modules.

### BACKGROUND

A fuel cell is an electrochemical cell that converts the chemical energy of a fuel and an oxidizing agent into electricity through a pair of redox reactions. In one example, hydrogen is the fuel and oxygen is the oxidizing agent. Fuel cells require a continuous source of fuel and oxygen to sustain the chemical reaction.

Fuel cells generally comprise three adjacent segments: the anode, the electrolyte, and the cathode. Two chemical reactions occur at the interfaces of the three different segments. The net result of the two reactions is that fuel is consumed, water is created and an electric current is created, which can be used to power electrical devices, electric vehicles and the like.

A catalyst oxidizes the fuel, usually hydrogen, at the anode turning the fuel into a positively charged ion and a negatively charged electron. The electrolyte is a substance specifically designed so ions can pass through it, but the electrons cannot. The freed electrons travel through a wire creating the electric current. The ions travel through the electrolyte to the cathode. Once reaching the cathode, the ions are reunited with the electrons and the two react with a third chemical, usually oxygen, to create water.

The assembling process of fuel cell stacks is complex. Applying a media module to connect several stacks is an additional production step that increases the cycle time and well as cost in terms of material and time.

Techniques are needed to provide fuel cell modules or housings that also being relatively easier and less costly to produce and/or assemble.

### BRIEF DESCRIPTION OF THE DRAWINGS

FIG. 1 is a diagram illustrating a fuel cell module in accordance with one or more embodiments.

FIG. 2 is a diagram illustrating the fuel cell module in accordance with one or more embodiments.

FIG. 3 is a diagram illustrating an example base in accordance with one or more embodiments.

FIG. 4 is a diagram illustrating the fuel cell module in accordance with one or more embodiments.

FIG. 5 is a diagram illustrating a perspective view of the plastic base 102 in accordance with one or more embodiments.

FIG. 6 is a diagram illustrating a method of fabricating a fuel cell module in accordance with one or more embodiments.

FIG. 7 is a diagram illustrating a fuel cell module in accordance with one or more embodiments.

FIG. 8 is a diagram illustrating a base in accordance with one or more embodiments.

### DETAILED DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

A fuel cell is an electrochemical cell that converts the chemical energy of a fuel and an oxidizing agent into electricity through a pair of redox reactions. In one example, hydrogen is the fuel and oxygen is the oxidizing agent. Fuel cells require a continuous source of fuel and oxygen to sustain the chemical reaction.

Fuel cells generally comprise three adjacent segments: the anode, the electrolyte, and the cathode. Two chemical reactions occur at the interfaces of the three different segments. The net result of the two reactions is that fuel is consumed, water is created and an electric current is created, which can be used to power electrical devices, electric vehicles and the like.

A catalyst oxidizes the fuel, usually hydrogen, at the anode turning the fuel into a positively charged ion and a negatively charged electron. The electrolyte is a substance specifically designed so ions can pass through it, but the electrons cannot. The freed electrons travel through a wire creating the electric current. The ions travel through the electrolyte to the cathode. Once reaching the cathode, the ions are reunited with the electrons and the two react with a third chemical, usually oxygen, to create water.

The assembling process of fuel cell stacks is complex. Applying a media module to connect several stacks is an additional production step that increases the cycle time and well as cost in terms of material and time.

Techniques are needed to provide fuel cell modules or housings that also being relatively easier and less costly to produce and/or assemble.

One or more embodiments are disclosed that provide fuel cell modules or housings that are simpler to assemble and utilize lower costs than other approaches.

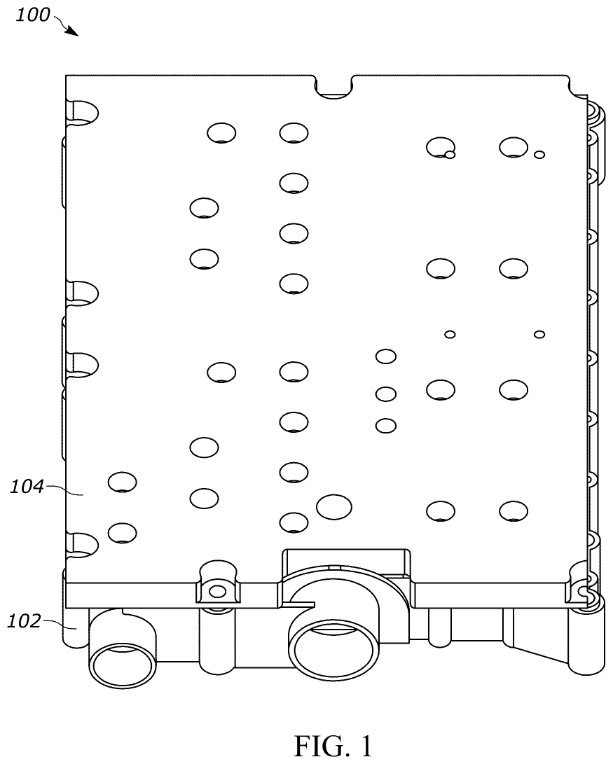

FIG. 1 is a diagram illustrating a fuel cell module 100 in accordance with one or more embodiments. It is appreciated that the module 100 is provided for illustrative purposes and that suitable variations are contemplated.

The module 100 includes a plastic base 102 and a plate 104. The plastic base comprises two components, a first for structure and a second for conveying channels. The first component can comprise plastic/polymer reinforced with glass fiber (GF) and configured to have increased strength. The second component is configured to have high insulation capabilities, media resistance, hydrogen resistance and the like. The components are typically comprised of varied materials. The plate 104 is generally coated with a layer or liner configured to meet or handle properties of materials or medium conveyed via the channels.

The plate 104 is typically comprised of aluminum and the like and also supports the coolant used and the fuel of the fuel cell. The plate 104 has the liner or coating configured to support Temperatures between −40-105° C., a coolant, filtered air, hydrogen, water, steam, and the like. The plate 104 material can also be configured to meet additional requirements such as Splashing water (or repeated immersion), Salt, UV radiation and heat radiation from sunlight, Rockfall, Solvents, acids and alkalis, fertilizers, operating fluids of motor vehicles (petrol, hydraulic fluids, battery acid, glycol and oils), and the like. The plate 104 can be comprised of or made out of sheet metal, castings, milling and the like to facilitate suitable insulation and sealing (only in areas where different media might contact the plate 104). These parts are clipped together for transportation by a suitable holding or attachment mechanism. The preassembled parts/module can be used in aa fuel cell system production line or assembly.

The plastic base 102 is comprise of one or more suitable polymer material(s) that supports the coolant used and the fuel of the fuel cell. The base 102 material(s) or the channel material used for the second component can also be configured to support Temperatures between −40-105° C., a coolant, filtered air, hydrogen, water, steam, and the like. The base 102 material(s) can also be configured to meet additional requirements such as Splashing water (or repeated immersion), Salt, UV radiation and heat radiation from sunlight, Rockfall, Solvents, acids and alkalis, fertilizers, operating fluids of motor vehicles (petrol, hydraulic fluids, battery acid, glycol and oils), and the like. The above requirements are also referred to as media resistance requirements.

It is appreciated that the media resistance requirements can vary based on application/use.

The plastic base 102 material can be lighter than the plate 104 material. Additionally, the plastic base 102 can be easily formed at a lower cost using suitable molding processes than similar bases made from aluminum and the like.

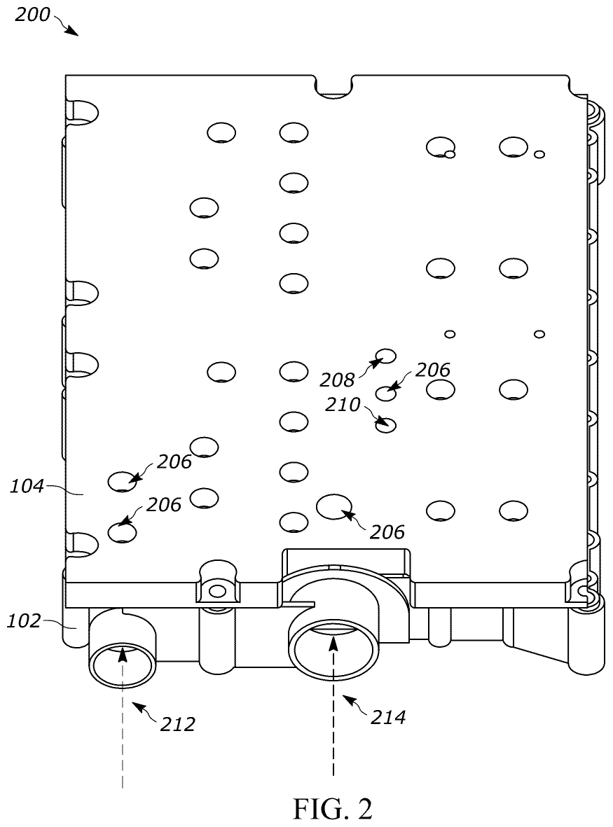

FIG. 2 is a diagram illustrating the fuel cell module 100, 200 in accordance with one or more embodiments. It is appreciated that the module 100, 200 is provided for illustrative purposes and that suitable variations are contemplated.

It is appreciated that the module 200 is provided for illustrative purposes and that suitable variations are contemplated. The module 200 is an example of the module 100.

The base 102 includes a cooling inlet (Cooling In) 212 shown on the left side and an air intake (Air In) 214 in the middle.

The plate 104 has a hydrogen input 208 and a water output 210.

A plurality of sensors 206 are shown integrated into the plate 104. The sensors 206 include pressure sensors, humidity sensors, hydrogen sensors and the like.

The plurality of sensors 206 can also be integrated in the plastic base 102, attached to the base 102 and the plate 104, and other suitable variations.

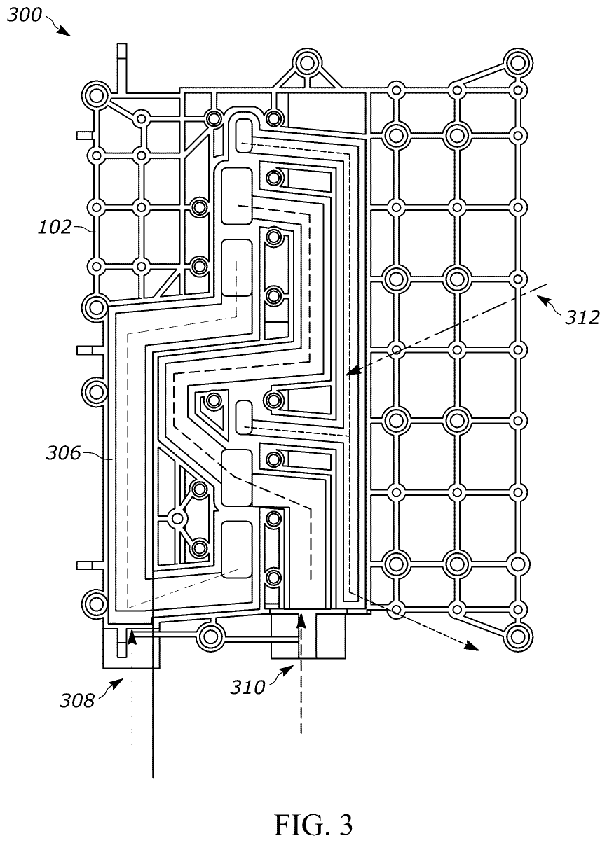

FIG. 3 is a diagram illustrating an example base 102, 300 in accordance with one or more embodiments. It is appreciated that the base 300 is provided for illustrative purposes and that suitable variations are contemplated. The base 300 is an example of a suitable base 102.

The base 300 includes a coolant channel 306 (also part of the second component) shown on the left side of the figure that conveys a suitable coolant therethrough from the coolant inlet 308.

The base 300 also includes an air channel 310 shown towards a middle of the figure that conveys air from an air inlet.

The base 300 includes a hydrogen/fuel channel 312 that conveys hydrogen as shown. The air channel 310 is between the fuel channel 312 and the coolant channel 306.

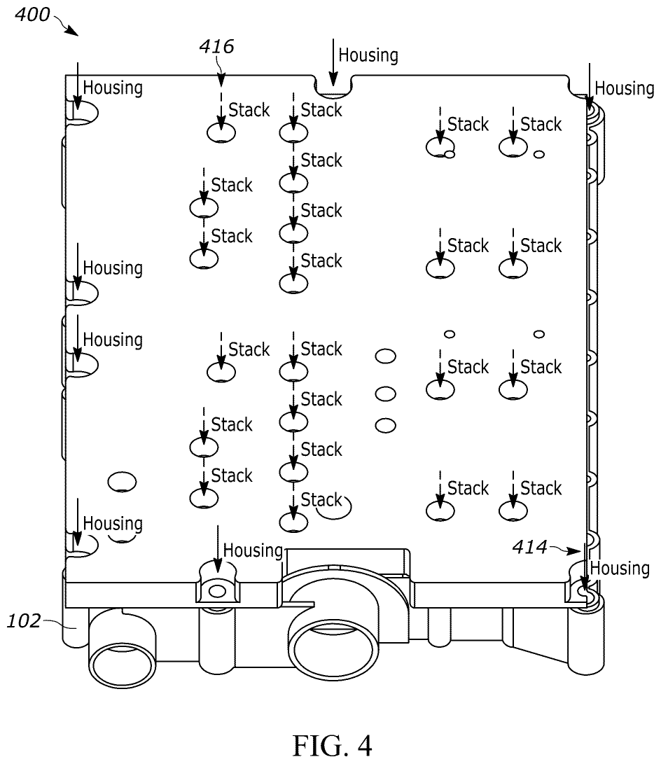

FIG. 4 is a diagram illustrating the fuel cell module 400 in accordance with one or more embodiments. It is appreciated that the module 100, 200, 400 is provided for illustrative purposes and that suitable variations are contemplated.

Various inserts or clips can be formed in the plastic base 102 to facilitate alignment with the plate 104. The clips can enable secure assembly of the module to a housing and fuel cell stacks.

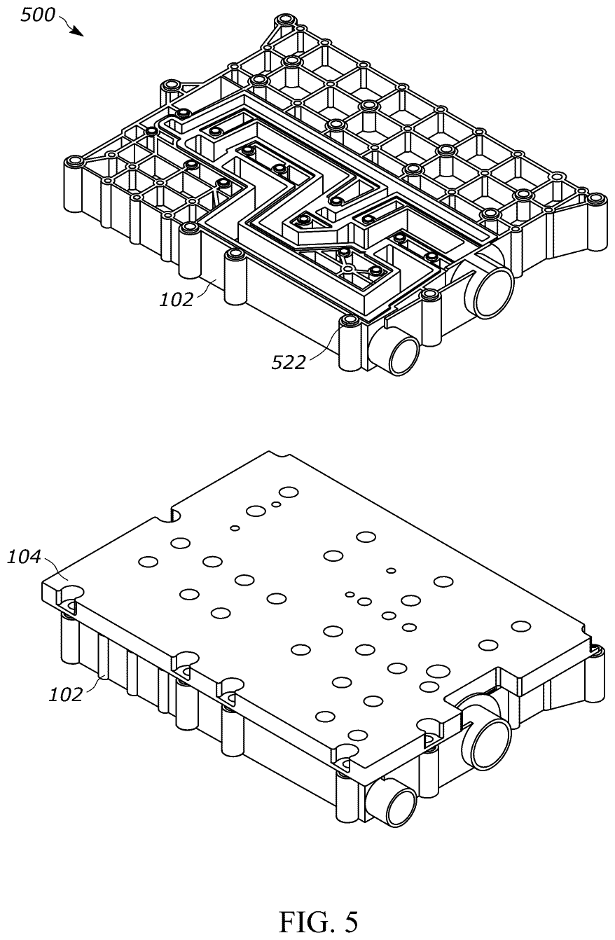

FIG. 5 is a diagram illustrating a perspective view 500 of the plastic base 102 in accordance with one or more embodiments.

An upper portion shows the plastic base 102 with attachment points 522 and the various channels formed therein.

The plastic base 102 is shown including geometric support structures (rectangular shaped in this example). The support structures enhance and/or facilitate strength and stability of the plastic base 102 to meet stress and strain requirements of similar fuel cell bases comprised of metal materials while at a lower cost and weight.

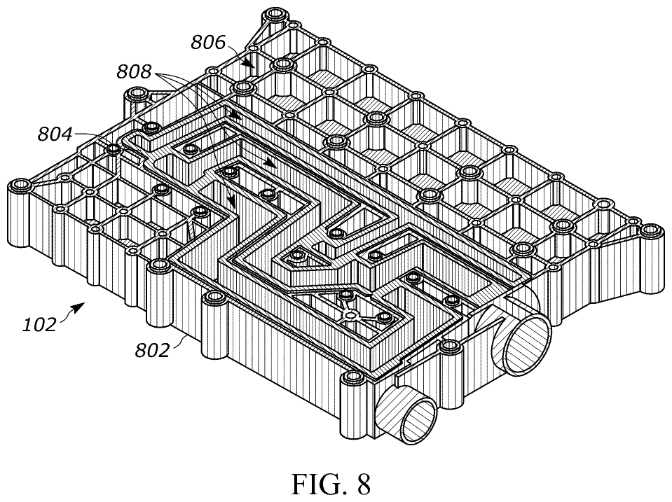

FIG. 8, shown below, shows a suitable example where structural material and channel material are utilized for separate components of the base 102.

A lower portion shows the plastic base 102 with the plate 104 attached thereon.

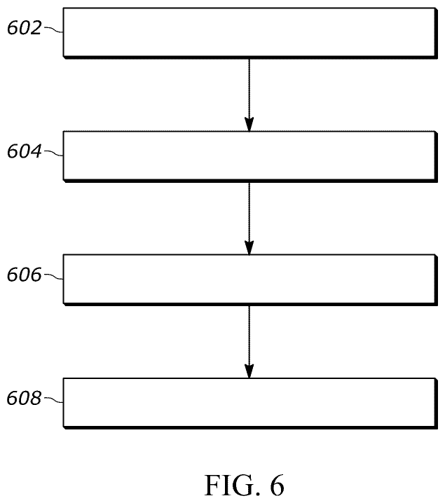

FIG. 6 is a diagram illustrating a method 600 of fabricating a fuel cell module 100 in accordance with one or more embodiments.

A plate 104 is formed from a suitable material, such as aluminum, at 602. The plate 104 is formed with a hydrogen/fuel input and a water output.

A plastic base 102 is formed from a suitable plastic material at block 604. The plastic base 102 is formed with a coolant channel, an air channel and a fuel channel. In one example, the plastic base 102 is formed using a mold. The plastic base 102 is also formed with a coolant inlet and an air inlet.

The plastic base 102 is formed with a configured support structure to meet or exceed strain and/or stress specifications.

The plate 104 and the plastic base 102 are formed as a module 100 at block 606. Adhesion, fasteners, housing inserts and the like can be used to attach the plate 104 and the plastic base 102.

A fuel cell using the module 100 can be operated at 608 to generate electricity from the hydrogen/fuel.

The method 100 can be performed/controlled using circuitry having one or more processors and the like.

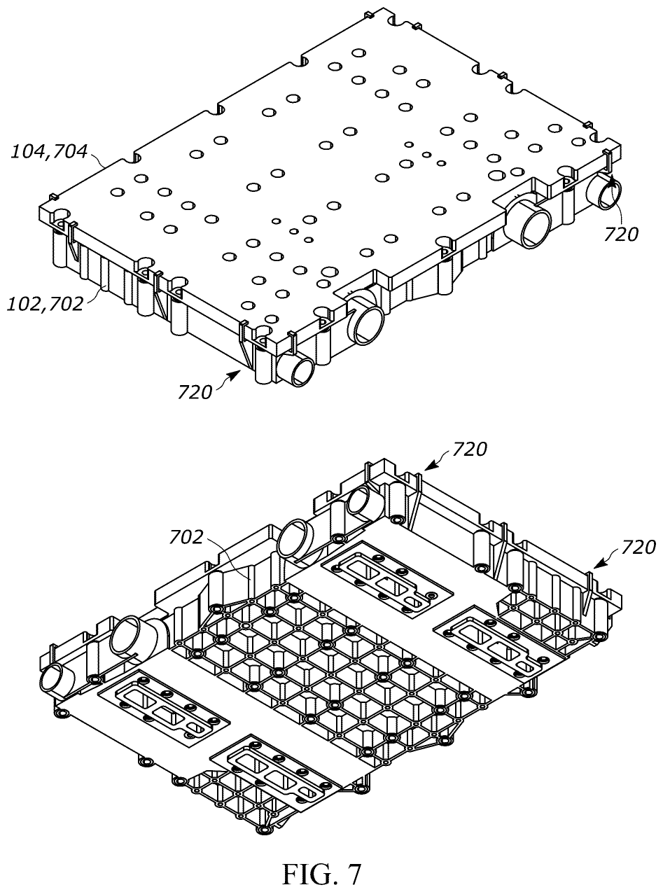

FIG. 7 is a diagram illustrating a fuel cell module in accordance with one or more embodiments. It is appreciated that the module is provided for illustrative purposes and that suitable variations are contemplated.

The module is an example of a suitable module 100.

Here, the module is shown with a plurality of clips 720 about the periphery. The clips are formed on the base 702, 102 and facilitate attachment of the plate 104 with the base 702, 102.

FIG. 8 is a diagram illustrating a base 102, 802 in accordance with one or more embodiments. It is appreciated that the base 102, 802 is provided for illustrative purposes and that suitable variations are contemplated.

The base 802 is shown comprising a structural material for a structural base part 804 and a channel material for 306, 312 and 314 channels.

The structural material comprises a polymer composition that provides structure and strength to the base 802. The composition is selected to meet or exceed strain and the like specifications.

The channel material is selected to meet or exceed specifications for materials or mediums conveyed by the channels 306, 310 and 312.

In one example, the channel material is selected to accommodate transport of hydrogen.

It is appreciated that other suitable variations are contemplated.

The narrower hatching generally shows the second component 808 or channel part 808 and the wider hatching generally shows the first component 806 or the structure part 806.

Various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Further, the actions of a method or algorithm described in connection with aspects disclosed herein can be embodied directly in hardware, in a software module executed by a processor, or a combination thereof. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the s and/or actions of a method or algorithm can reside as one or any combination or set of codes and/or instructions on a machine-readable medium and/or computer readable medium, which can be incorporated into a computer program product.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “adjacent”, “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It should be added that ‘having’ does not exclude other elements or steps and ‘one’ or ‘one’ does not exclude a multitude. It should also be noted that characteristics described with reference to one of the above examples of execution can also be used in combination with other characteristics of other examples of execution described above. Reference signs in the claims are not to be regarded as a restriction.

Various examples are provided, however it is appreciated that suitable variations are contemplated.

One example is a fuel cell module that includes a plastic base and an aluminum plate. The plastic base 102 is comprised of a polymer material. The plastic base 102 comprises a coolant inlet, an air inlet, a coolant channel, an air channel and a fuel channel. The aluminum plate 104 is attached to a top portion of the plastic base 102. The plate 104 can comprises a fuel inlet and a water outlet that connect to the fuel channel of the plastic base

One general aspect includes a fuel cell module 100. The fuel cell module also includes a plastic base 102 that may include of one or more polymer materials and having a structural part and a channel part, the plastic base may include a coolant inlet, an air inlet, a coolant channel, an air channel and a fuel channel; a metal plate 104 attached to a top portion of the plastic base, the plate may include a fuel inlet and a water outlet.

Implementations may include one or more of the following features. The material configured to mitigate corrosion from and support use of a fuel in the fuel channel and a coolant in the coolant channel. The fuel is hydrogen. The fuel cell module 100 where one of the polymer materials may include a resin to reach media resistance requirements. The fuel cell module 100 where the plate 104 formed by milling, die casting and/or cutting sheet metal. The fuel cell module 100 where the plate 104 may include a sealing configured to meet media resistance requirements. The fuel cell module 100 where the plastic base 102 and the plate 104 attached via an adhesive. The fuel cell module 100 where the plastic base 102 may include clips 416, 414 to facilitate attachment to the plate 104. The fuel cell module 100 where the plastic base 102 may include a sealant layer formed on at least the fuel channel to meet media requirements of hydrogen fuel. The fuel cell module 100 where the plastic base 102 may include a second sealing layer formed on at least the coolant channel to meet media requirements of a coolant. The fuel cell module 100 where the plastic base 102 may include a sealant layer formed on at least the fuel channel allowing different or non-resin plastic material to be used for the channels. The fuel cell module 100 where the channel part may include a resin plastic material and the structure part may include a non-resin plastic material.

One general aspect includes a method 600 of fabricating a fuel cell module. The method 600 of fabricating also includes forming a plate using aluminum material. The method 600 of fabricating also includes coating an interior surface of the plate with a media resistant material. The method 600 of fabricating also includes forming a plastic base from a polymer material, the base formed having a coolant channel, an air channel and a fuel channel. The method 600 of fabricating also includes stacking the plate with the plastic base to form the fuel cell module.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A fuel cell module comprising:
a plastic base comprised of one or more polymer materials and having a structural part and a channel part, the channel part comprising a coolant inlet, an air inlet, a coolant channel, an air channel and a fuel channel;
the structural part comprising a glass fiber reinforcement; and
a metal plate attached to a top portion of the plastic base, the plate comprising a fuel inlet and a water outlet.

2. The fuel cell module of claim 1, the polymer material configured to mitigate corrosion from and support use of a fuel in the fuel channel and a coolant in the coolant channel.

3. The fuel cell module of claim 2, the fuel is hydrogen.

4. The fuel cell module of claim 1, one of the polymer materials comprising a resin to reach media resistance requirements.

5. The fuel cell module of claim 1, the plate formed by milling, die casting and/or cutting sheet metal.

6. The fuel cell module of claim 1, the plate comprising a sealing configured to meet media resistance requirements.

7. The fuel cell module of claim 1, the plastic base and/or the plate comprising one or more integrated sensors.

8. The fuel cell module of claim 1, the plastic base and the plate attached via an adhesive.

9. The fuel cell module of claim 1, the plastic base comprising clips to facilitate attachment to the plate 104.

10. The fuel cell module of claim 1, the plastic base comprising a sealant layer formed on at least the fuel channel to meet media requirements of hydrogen fuel.

11. The fuel cell module of claim 10, the plastic base comprising a second sealing layer formed on at least the coolant channel to meet media requirements of a coolant.

12. The fuel cell module of claim 1, the plastic base comprising a sealant layer formed on at least the fuel channel allowing different or non-resin plastic material to be used for the channels.

13. The fuel cell module of claim 1, the channel part comprising a resin plastic material and the structure part comprising polymer and glass fiber (GF) as reinforcement.

14. A method of fabricating a fuel cell module, the method comprising:
forming a plate using aluminum material;
coating an interior surface of the plate with a media resistant material;
forming a plastic base from a polymer material, the base formed having a coolant channel, an air channel and a fuel channel; and
stacking the plate with the plastic base to form the fuel cell module.

15. The method of claim 14, forming the plastic base comprises forming a structure part that includes glass fiber as a reinforcement and forming a channel part comprised of a resin material.

16. The method of claim 14, forming the plate comprises die casting the aluminum material.

17. The method of claim 14, further comprising forming the fuel channel with a resin plastic material.

18. The method of claim 17, further comprising forming the plastic base with attachment points.

19. The method of claim 14, further comprising integrating hydrogen sensors into the plate.

20. The method of claim 19, further comprising integrating additional sensors into the plate.
